(19) United States
(12) Patent Application Publication
(10) Pub. No.: US 2025/0002408 A1
(43) Pub. Date: Jan. 2, 2025

(54) BRICKS/PAVERS MADE FROM DESALINATED SEDIMENT AND PROCESS OF MAKING SAME

(71) Applicants: The Belden Brick Company, LLC, Canton, OH (US); Eco-Ash, LLC, Baltimore, MD (US)

(72) Inventors: Robert T. Belden, Canton, OH (US); Robert W. Ittmann, Gulf Stream, FL (US)

(21) Appl. No.: 18/697,641

(22) PCT Filed: Oct. 2, 2022
(86) PCT No.: PCT/US2022/045479

§ 371 Date: Apr. 1, 2024

Related U.S. Application Data
(60) Provisional application No. 63/251,083, filed on Oct. 1, 2021.

(51) Int. Cl. C04B 18/04; C04B 20/02; C04B 20/04; C04B 28/02; C04B 40/00

(52) U.S. Cl. CPC C04B 18/0436; C04B 20/026; C04B 20/04; C04B 28/021; C04B 40/0082

(57) ABSTRACT

A process and brick made therefrom uses a material sourced from a brackish waterway. The process includes at least partially drying the removed sediment material to reduce the water content thereof, passing the sediment material through a screen subsequent to the drying step to obtain dried material of a predetermined size; grinding the dried material passed through the screen to a second predetermined size; passing the ground material through a hydraulic press filter to remove salt therefrom; and using the desalinated ground material as a substitute for at least some of an amount clay used in making conventional bricks.

This application claims the priority benefit of U.S. provisional Ser. No. 63/251,083, filed Oct. 1, 2021, the entire disclosure of which is expressly incorporated herein by reference.

### BACKGROUND

This disclosure relates to making bricks and more particularly to a process of manufacturing bricks, pavers, floor tiles, possibly roof tiles, etc., (hereafter generically referred to as bricks) utilizing a material removed from a brackish waterway, and the resultant bricks manufactured by the manufacturing process. Selected aspects of the present disclosure may find application in related manufacturing processes.

Brick manufacturing is well known and has been developed over thousands of years so that even today the commercial process is substantially unchanged over many years. By way of example only, a green body is formed by mixing constituents that include about 50% to about 60% by weight of sand or silica, approximately 20% to about 30% by weight of alumina or dry clay (shale); about 2 to 5% by weight of lime, approximately 7% by weight of iron oxide, less than about 1% by weight of magnesia, and water. The green body is subsequently dried to remove moisture in the brick, then fired to fuse or vitrify the components, and next cooled in a controlled manner to result in the final brick that has structural strength and integrity as widely used in the construction industry.

The most widely used commercial processes are either to mold or press mold the bricks or alternatively to extrude the bricks. In order to make press molded bricks the clay/shale is first ground, mixed with water and the other components to the desired consistency. The clay is then pressed into molds with a press, and the molded clay is then fired or burned at approximately 900-1150° C. to achieve strength. Alternatively, the bricks subsequently move slowly through a tunnel kiln on conveyors, rails, or kiln cars. The bricks often have added lime, ash, and organic matter to speed the burning process.

In contrast, with extruded brick, ground clay/shale is mixed with 10-25% water and the material is pushed or forced through a die to form the desired width and depth of the green body. The extrudate is subsequently cut into bricks of a desired length. The cut bricks are then dried for about 20 to 40 hours at up to approximately 400° F. to harden before being fired in the kiln. Oftentimes, the heat for drying is residual heat from the kiln.

Like any process, manufacturers are constantly evaluating new materials and processes in an effort to reduce the cost of the final product, and particularly without any loss in performance of the manufactured product. Various attempts to incorporate different low-cost materials into the brick have been made. For example, one constant source of material for brick manufacture that has been investigated by the inventors of the present application relates to using material dredged from brackish waterways because the sediment/dredge material is a de facto clay material, i.e., there is enough clay in the sediment/dredge material for use in manufacturing brick. Ideally, it would be most advantageous to use 100% sediment/dredge material in a process of making bricks; however, the feasibility of achieving this goal was unknown. This material is periodically being removed (typically dredged) from waterways to improve navigation and much of the dredge material ends up in impoundments at great expense to the various governmental agencies involved with the ongoing project. A significant potential savings could be achieved versus continuing to divert the dredge material in impoundments. Such dredge materials have been investigated for reuse in other applications such as a topsoil alternative in highway applications (see technical report entitled “Soluble Salts Reduction And Metals Behavior Of Dredged Sediment For Reuse In Highway Slope Applications” prepared by Michelle Huffert, Ahmet Aydilek, and Allen P. Davis of the Department of Civil and Environmental Engineering, University of Maryland-College Park for the Maryland Department of Transportation, Maryland Port Administration), the entire disclosure of which is incorporated herein by reference.

One significant hurdle relates to the salt in the dredge material taken from brackish waterways. Although it has been proposed in one recycling effort that washing and rinsing of the brackish dredge material might reduce the salinity level of the dredge material, this is only achieved after repeated washing/rinsing cycles over an extended period of time (one year). Thus, this has been a significant impediment to commercial application of using the dredge materials from brackish waterways, and generally deemed unfeasible.

A need exists to develop a process that can effectively and economically remove the salt from dredge material sourced from brackish waterways, and thereby include a greater content of the desalinated dredge material as a substitute for at least some of the clay/shale component incorporated in the commercial manufacture of bricks. Preferably this can be achieved without any adverse impact on the quality of the bricks, e.g., strength, integrity, color, while simultaneously not significantly impacting or altering the commercial process of providing brick feedstock or brick manufacture so that the overall process is still cost effective, sustainable, and environmentally friendly. In certain instances where the dredge material includes lots of iron oxide material therein, it can be necessary to expose sufficient surface area of the bricks (by edge setting the bricks, for example, on variable firing trays) during the firing process so that resultant gases can escape.

A need exists for an improved process that provides at least one or more of the above-described features, as well as still other features and benefits.

### SUMMARY

There is provided a new process for making bricks using sediment material from a brackish waterway from which salt has been removed.

More particularly, the process of making bricks using a material sourced from a brackish waterway includes the steps of at least partially drying the removed sediment material to reduce the water content thereof, passing the sediment material through a screen subsequent to the drying step to obtain dried material of a predetermined size, grinding the dried material passed through the screen to a second predetermined size, passing the ground material through a hydraulic press filter to remove salt therefrom, and using the desalinated ground material as a substitute for at least some of an amount clay used in making conventional bricks.

The passing step preferably includes using a screen having openings of approximately 3/16″ (approximately 4.8 mm).

The passing step includes using a screen having openings of approximately ⅜″ (approximately 9.5 mm) and subsequently introducing the pass-through material therefrom into the approximately 3/16″ (approximately 4.8 mm) screen.

The passing step includes using a screen having openings of approximately ½″ (approximately 13 mm).

Subsequent to the screening step, the process may include grinding the dredged material.

The drying step includes removing water in the amount of approximately one-fourth the volume of the sediment material.

The process includes removing sediment material from the brackish waterway.

The sediment material removing step preferably includes dredging the material from the bottom of the brackish waterway.

A primary benefit of the present disclosure relates to manufacturing bricks/pavers on a commercial scale using dredged material that meet ASTM performance criteria (I.e., comparable to or exceeding traditional clay/shale pavers).

An associated benefit is the ability to effectively and efficiently remove salt from the sediment (dredged) material from a brackish waterway.

Another advantage resides in the ability to redirect material otherwise destined for a landfill.

Still other benefits include using/repurposing a large volume of dredged material that is otherwise destined for disposal and reclaiming a portion of that material for a manufactured product.

Yet another advantage related to successfully firing the bricks/pavers by edge setting of pavers.

A further advantage is achieved by using dredged material to make bricks/pavers that can be profitably sold at a price equal to or less than traditional clay/shale bricks/pavers.

Still further advantages relate to the environmental and monetary advantages achievable by using desalinated dredge material as a substitute for at least some of the clay with this brick manufacturing process.

Still other advantages and benefits of the present disclosure will become more apparent from reading and understanding the following detailed description.

### BRIEF DESCRIPTION OF THE DRAWINGS

FIG. 1 illustrates retentate (unusable material) after the dried dredge material passes through a first screen having large, 1½ inch openings.

FIG. 2 shows a dryer section into which dredge material is introduced.

FIG. 3 shows a portion of a screen section preferably located along an interior of the dryer section of FIG. 2 having ½ inch (13 mm) openings.

FIG. 4 shows sequential screen sections having ⅜ inch (9.5 mm) openings, then 3/16 inch (4.6 mm) openings.

FIG. 5 shows the dredge material in granular form after exiting the 3/16 inch (4.6 mm) screen.

FIG. 6 shows ground, dried dredge material after the screened material has been sent through a ball mill to grind the dried dredge material to a size ranging from approximately 1.15 mm to approximately 2.5 mm.

FIG. 7 shows a conventional hydraulic filter press that receives the ground dredge material in slurry form.

FIG. 8 shows green bricks after desalinated dredge material has been mixed with the other constituents to form the green bricks.

### DETAILED DESCRIPTION

The following description with reference to the accompanying drawings is provided to assist in a comprehensive understanding of one or more embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. Various exemplary embodiments of the present disclosure are not limited to the specific details of different embodiments and should be construed as including all changes and/or equivalents or substitutes included in the ideas and technological scope of the appended claims. In describing the drawings, where possible similar reference numerals are used for similar elements.

The terms “include” or “may include” used in the present disclosure indicate the presence of disclosed corresponding functions, operations, elements, and the like, and do not limit additional one or more functions, operations, elements, and the like. In addition, it should be understood that the terms “include”, “including”, “have” or “having” used in the present disclosure are to indicate the presence of components, features, numbers, steps, operations, elements, parts, or a combination thereof described in the specification, and do not preclude the presence or addition of one or more other features, numbers, steps, operations, elements, parts, or a combination thereof.

The terms “or” or “at least one of A or/and B” used in the present disclosure include any and all combinations of words enumerated with them. For example, “A or B” or “at least one of A or/and B” mean including A, including B, or including both A and B.

Although the terms such as “first” and “second” used in the present disclosure may modify various elements of the different exemplary embodiments, these terms do not limit the corresponding elements. For example, these terms do not limit an order and/or importance of the corresponding elements, nor do these terms preclude additional elements (e.g., second, third, etc.) The terms may be used to distinguish one element from another element. For example, a first mechanical device and a second mechanical device all indicate mechanical devices and may indicate different types of mechanical devices or the same type of mechanical device. For example, a first element may be named a second element without departing from the scope of the various exemplary embodiments of the present disclosure, and similarly, a second element may be named a first element.

It will be understood that, when an element is mentioned as being “connected” or “coupled” to another element, the element may be directly connected or coupled to another element, and there may be an intervening element between the element and another element. To the contrary, it will be understood that, when an element is mentioned as being “directly connected” or “directly coupled” to another element, there is no intervening element between the element and another element.

The terms used in the various exemplary embodiments of the present disclosure are for the purpose of describing specific exemplary embodiments only and are not intended to limit various exemplary embodiments of the present disclosure. As used herein, the singular forms are intended to include the plural forms as well, unless the context clearly indicates otherwise.

All of the terms used herein including technical or scientific terms have the same meanings as those generally understood by an ordinary skilled person in the related art unless they are defined otherwise. The terms defined in a generally used dictionary should be interpreted as having the same meanings as the contextual meanings of the relevant technology and should not be interpreted as having inconsistent or exaggerated meanings unless they are clearly defined in the various exemplary embodiments.

This written description uses examples to describe the disclosure, including the best mode, and also to enable any person skilled in the art to make and use the disclosure. Other examples that occur to those skilled in the art are intended to be within the scope of the invention if they have structural elements that do not differ from the same concept or that do not differ from the literal language of the claims, or if they include equivalent structural elements with insubstantial differences from the same concept or from the literal language of the claims. Moreover, this disclosure is intended to seek protection for a combination of components and/or steps and a combination of claims as originally presented for examination, as well as seek potential protection for other combinations of components and/or steps and combinations of claims during prosecution.

A conventional process generally has a recipe of approximately 50% by weight silica (SiO2) (sand, per se, is not used in the body of brick). In addition, the material includes approximately 20% to about 30% by weight of alumina or clay (shale); about 2 to 5% by weight of lime, approximately 7% by weight of iron oxide, and less than about 1% by weight of magnesia. The clay/ground shale materials are processed by crushing and grinding, and mixing the crushed/ground material together with water and the remaining ingredients.

In accordance with the teachings of the present disclosure, at least a portion of the clay is substituted with sediment material. The sediment material used herein is from a brackish waterway (typically through a dredging process). It is important for the salt to be removed from the sediment material/dredge material for use in the brick manufacturing process. The salt removal process in one preferred testing process lowers the soluble sodium (Na) content from about 3.1% to about 0.14%.

TABLE 1

| | | Dredged | Dredged | | | |
|---|---|---|---|---|---|---|
| | | Material - | Material - | | | |
| | | Pre Salt | Post Salt | Belden | Belden | Maryland |
| Parameter | Unit | Removal | Removal | Clay | Shale | Fly Ash |
| Water Soluble Salts | | | | | | |
| Ca as CaO | % mass | 0.011 | <0.011 | 0.040 | 0.012 | 0.65 |
| Na as Na₂O | % mass | 3.1 | 0.14 | 0.0026 | 0.0011 | 0.0065 |
| K as K₂O | % mass | 0.014 | 0.0032 | 0.011 | 0.0023 | 0.0042 |
| Mg as MgO | % mass | 0.0061 | <0.0008 | 0.015 | 0.0023 | 0.011 |
| S as SO₄ | % mass | 0.66 | 0.090 | 0.13 | 0.0031 | 1.2 |
| Electrical | mS/m | 711 | 46 | 33 | 6.6 | 181 |
| Conductivity | | | | | | |
| Cl | % mass | 0.025 | 0.0028 | — | — | — |

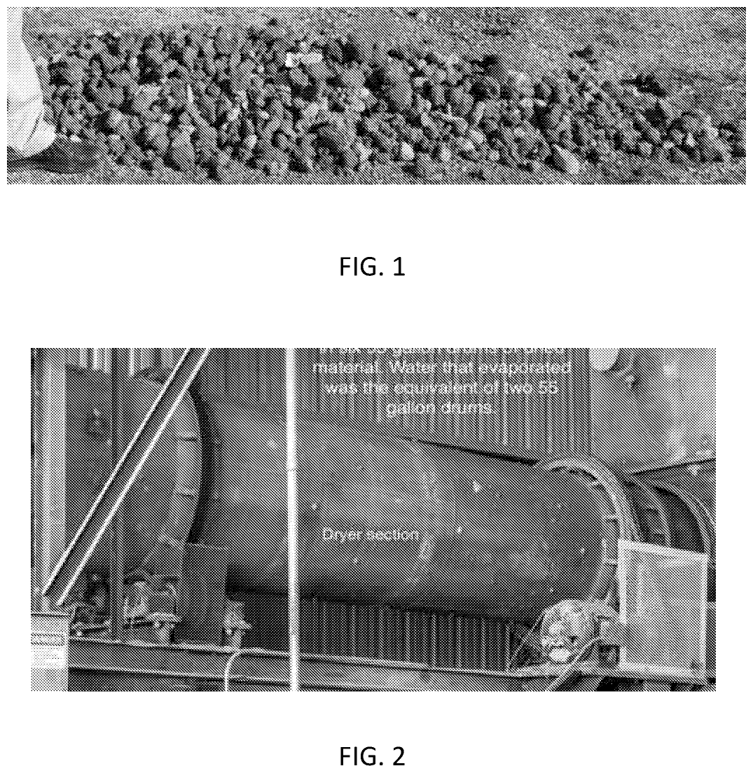

To achieve this, the sediment/dredge material is initially dried in an open environment and may be passed through a first screen (not shown), e.g., on the order of one and half inch openings in the screen to remove undesired/unusable material 100 (FIG. 1). Thereafter, the dredge material is introduced into a commercial dryer 110 (FIG. 2) where the dredge material is exposed to elevated temperatures to remove moisture therefrom. Preferably the dredge material passes through the dryer 110 more than once resulting in further evaporation of moisture from the dredge material. It is estimated that the drying step removes water in the amount of approximately one-fourth the volume of the initial volume of sediment material introduced into the dryer 110.

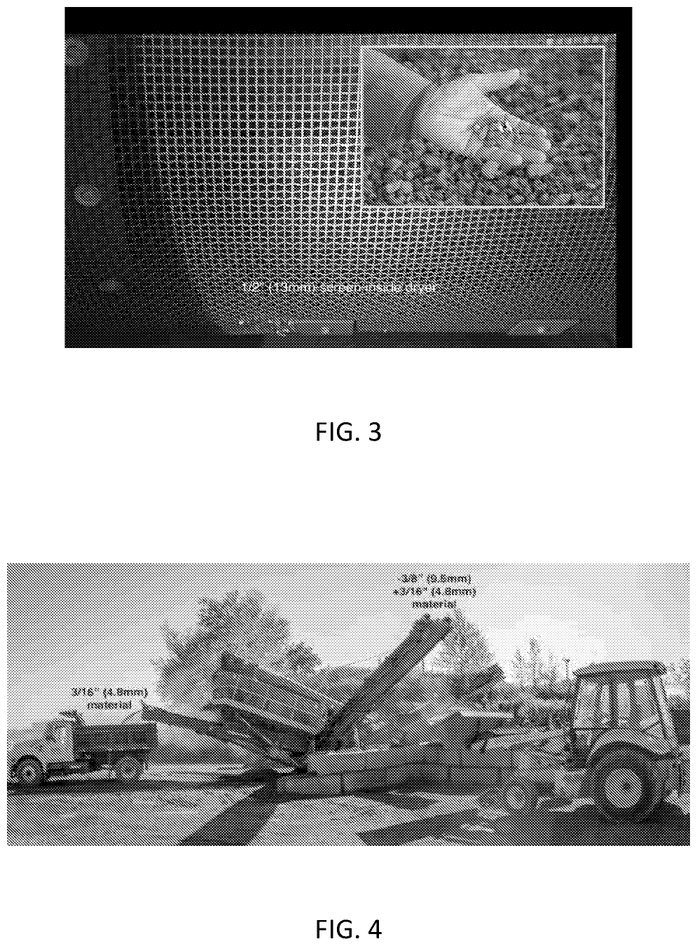

As shown in FIG. 3, an additional screen 120 may be provided in the dryer 110. The additional screen 120, in a first preferred arrangement, has openings of ½ inch (13 mm) that further reduces the volume of usable dredge material.

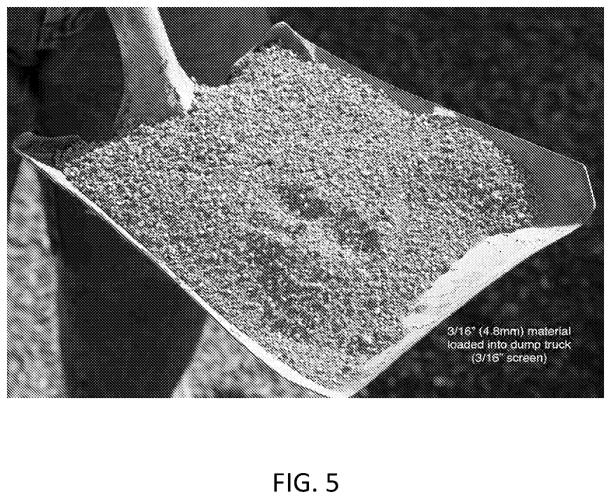

Preferably the usable dredge material that passes through the ½ inch (13 mm) screen 120 of FIG. 3 is passed through additional screens (FIG. 4). By way of example only, two additional screens of ⅜ inch (9.5 mm) and 3/16 inch (4.8 mm), respectively, result in a fine 3/16 inch (4.8 mm) granular material 130 (FIG. 5).

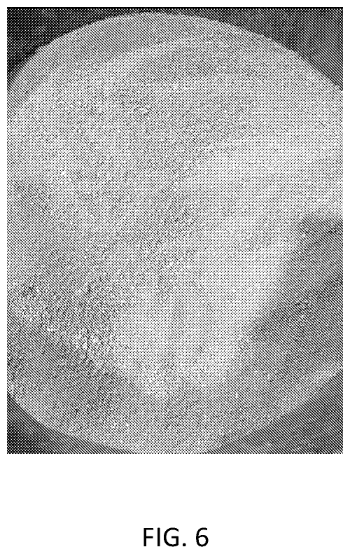

The granular material 130 of FIG. 5 is introduced into a ball mill, for example, which grinds the dredge material to a fine grind material 140 (FIG. 6) having a dimension ranging from approximately 1.15 mm to approximately 2.5 mm. Water is added to this ground dried dredge material 140 to form a slurry.

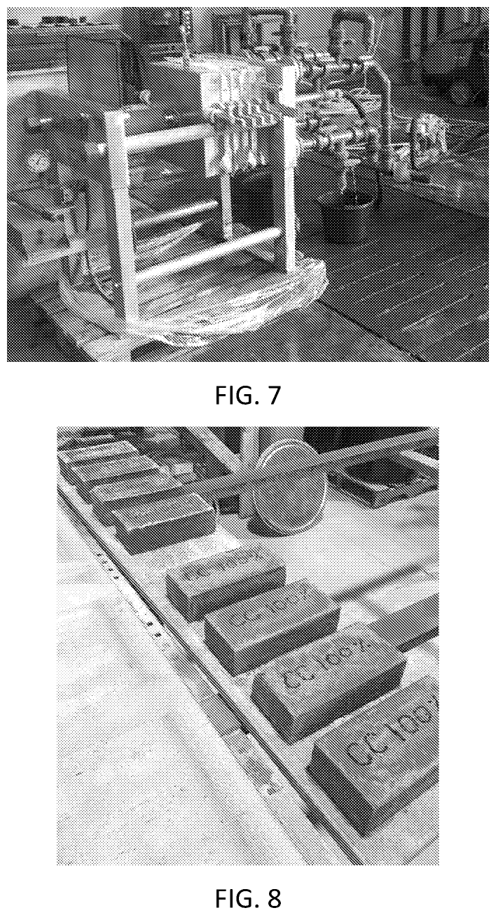

The slurry is then introduced into a filter press 150 (FIG. 7) which is a well-known, commercial equipment used in liquid/solid separation. Specifically, the filter press 150 separates the liquids and solids using pressure filtration. Generally, the slurry is pumped into the filter press 130 and is dewatered under pressure. Steps associated with a filter press 150 include filling the press with the slurry, squeezing the membranes to remove the water (which also advantageously desalinates the dredge material), and then removing the dewatered cakes from the filter press. The desalinated cakes are then used as the substitute for the clay/shale of a traditional mixture of materials used to form green bricks 160 (FIG. 8) in a conventional brick manufacturing process.

Approximately 95% of the salt is removed with a single pass through the filter press, and up to 98% of the salt is removed with three separate washings/passes though the hydraulic press. The removal of salt is significant since undesired discoloring (e.g., either a glaze is formed on the final brick or white/gray corners result on the fired bricks) can result if a significant amount of salt remains in the desalinated cakes subsequent to the hydraulic press. Although historically other materials (e.g., barium carbonate) have been added to the recipe to address and neutralize the salt, a significant amount of neutralizing material would be required in order to prevent the formation of the glaze—and the glaze is extremely difficult if not impossible to effectively remove in a commercial process.

The mixture used in the formed green bricks 160 of FIG. 8 use the desalinated dredge material, for example through a molding process, and then the formed bricks are dried. The formed brick 160 is next fired at an elevated temperature, for example in a kiln, to increase the hardness and strength. Then the fired brick is subsequently cooled.

Recipes currently tested with favorable results using dredged material from a brackish waterway as a substitute for some or all of the clay in a brick recipe include:
Mix #1: 100% dredged material;
Mix #2: 70% dredged material and 30% clay;
Mix #3: 70% dredged material; 7.5% clay; 7.5% shale; and 15% fly ash;
Mix #4: 70% dredged material and 30% fly ash;
Mix #5. 70% dredged material, 15% shale, 15% fly ash;
Mix #6. 50% dredged material, 25% clay, 25% shale;
Mix #7. 60% dredged material, 20% shale, 20% fly ash;
Mix #8. 80% dredged material, 10% shale, 10% fly ash.
   A press filter is needed to remove the salt from the brackish sediment/dredge material. It was determined that when using 100% dredge material in the brick recipe, too much water was present in the 100% dredge material cake from the press mold. To address this issue, approximately 30%-50% of the dredge material was dried to remove the excess water. Thus, the additional drying step of dredge material is helpful in developing a commercially viable product in the brick making process.

Test results for Mix #1 and Mix #4 were both found to pass the ASTM tests for water absorption, compressive strength, abrasion resistance, and freeze/thaw. It is thus concluded that at least these two recipes #1 and #4 can be used to produce permeable paver products with characteristics that meet or exceed those characteristics found in products made from traditional brick and paver feedstocks such as clay and shale (e.g., ASTM C902-Standards for Pedestrian and Light Traffic Paving Brick). Further, while the salt content of the original dredged material was about 3%, tests showed that salt could be successfully removed by washing the dredged material with water and pressing the material with a filter press machine to remove the dissolved salts. Testing indicates that a single wash using this method lowers the salt content of the dredged material to about 0.13%, which is an acceptable level for the dredged material to be used as a brick or paver. The small amount of residual salt in the dredged material can be neutralized by using common brick-making techniques such as the addition of barium carbonate.

The dredge material pavers should be edge set during the firing process to provide sufficient dissipation of gases produced from ignition of organic materials used in these recipes since using the variable firing tray (VFT) described in U.S. Pat. No. 9,776,921, that is expressly incorporated herein by reference, allows the bricks to maintain their shape due to the increased exposed surface area for dissipation produced from edge setting.

The use of the dredged material to produce ceramic permeable pavers also has numerous environmental benefits. For example, sintering (at a temperature about 2000 degrees F.) permanently traps pollutants in the ceramic matrix of the paver body; using dredged materials in place of traditional brick feedstocks can reduce the natural gas required for kiln firing of the products; the process described herein can reduce stormwater runoff when permeable pavers/bricks manufactured with the dredged materials are used in parking lots, sidewalks, and roads; and dredged material pavers can be sold at equal or less than the price of traditional clay and shale pavers.

Of course, these recipes are exemplary only and intended to illustrate the inclusion of the dredged material into the brick making process. In addition, the sediment/dredged material may be used in combination with fly ash as noted in some of the above mixtures. Commonly owned U.S. Pat. No. 9,776,921 is expressly incorporated herein by reference with respect to use of fly ash in forming bricks and pavers, and using variable firing trays in the manufacturing process.

The ingredients that are mixed with water in a mixer to form the green bricks may also be combined with recycled waste portions of dried bricks that have not passed quality control from one or more locations downstream in the process. For example, waste from damaged bricks resulting from positioning on pallets or waste from damaged bricks exiting a dryer are added into the mixer.

The mixture enters a mold press where green bricks of various preselected dimensions are formed or molded and positioned on pallets. The green products are subsequently loaded on to dryer racks for drying in a dryer for approximately 15 hours. Once the drying period has expired, the dried products are unloaded and dried bricks are removed from the pallets. For example, and without limiting the present disclosure, fired pavers/bricks may be formed in various sizes (including conventional fired sizes of 4×8×2¼; 4×8×2¾*; 4½×9×2¼; 8×8 2¼*; 8×8×2¾*; 6×6×2¼*; 6×6×2¾*; 6×9×2¼*; 6×9×2¾*; 4×12×2¼*; 4×12×2¾*; 5×10×2¼*; and 5×10×2¾*; 3×7⅝×2¼*; 3×7⅝×2¾*; 3×11⅝×2¼*; and 3×11⅝×2¾*; etc.). Those brick/paver sizes identified with an asterisk can only be made with the present commercial process because a traditional commercial kiln would not be able to economically fire/oxidize these larger and/or thicker products.

Next, the dried products are set on kiln cars. The kiln cars are introduced into a tunnel kiln and the dried products are fired for more than two days and less than three days, approximately 55-70 hours. The variable firing trays (VFTs) are then removed from the kiln cars, and the fired product (individual bricks) is removed or unloaded from the VFTs. The VFTs are useful in allowing the individual bricks to be edge set (i.e., orienting the brick so that the shortest edge of brick extends horizontally during the firing process) and commercially fired which improves the acceptability and quality of the final sintered product.

Although specific advantages have been enumerated above, various embodiments may include some, none, or all of the enumerated advantages. Although exemplary embodiments are illustrated in the figures and description herein, the principles of the present disclosure may be implemented using any number of techniques, whether currently known or not. Moreover, the operations of the systems and apparatuses disclosed herein may be performed by more, fewer, or other components, and the methods described herein may include more, fewer, or other steps. Additionally, steps may be performed in any suitable order.

To aid the Patent Office and any readers of this application and any resulting patent in interpreting the claims appended hereto, applicants do not intend any of the appended claims or claim elements to invoke 35 USC 112 (f) unless the words “means for” or “step for” are explicitly used in the particular claim.

The disclosure has been described with reference to the preferred embodiments. Obviously, modifications and alterations will occur to others upon reading and understanding the preceding detailed description. It is intended that the disclosure be construed as including all such modifications and alterations.

We claim:

1. A process of making bricks using a material sourced from a brackish waterway comprising the steps of:
at least partially drying the removed sediment material to reduce the water content thereof;
passing the sediment material through a screen subsequent to the drying step to obtain dried material of a predetermined size;
grinding the dried material passed through the screen to a second predetermined size;
passing the ground material through a hydraulic press filter to remove salt therefrom; and
using the desalinated ground material as a substitute for at least some of an amount clay used in making conventional bricks.

2. The process of claim 1 wherein the passing step includes using a screen having openings of approximately 3/16″ (approximately 4.8 mm).

3. The process of claim 2 wherein the passing step includes using a screen having openings of approximately ⅜″ (approximately 9.5 mm) and subsequently introducing the pass-through material therefrom into the approximately 3/16″ (approximately 4.8 mm) screen.

4. The process of claim 3 wherein the passing step includes using a screen having openings of approximately ½″ (approximately 13 mm).

5. The process of claim 1 wherein the ground material has a size on the order of approximately 1.15 m to 2.5 mm.

6. The process of claim 1 wherein the drying step includes removing water in the amount of approximately one-fourth the volume of the sediment material.

7. The process of claim 1 further comprising removing sediment material from the brackish waterway.

8. The process of claim 7 wherein the sediment material removing step includes dredging the material from the bottom of the brackish waterway.

9. The process of claim 1 wherein the drying step includes passing the sediment material through a dryer at least twice.

10. The process of claim 1 wherein a sodium (Na) content of the sediment material is less than about 0.15%.

11. The process of claim 1 further comprising firing the bricks on edge.

12. The process of claim 1 further comprising using at least 50% sediment material in a feedstock or blend of the brick.

13. The process of claim 12 further comprising using fly ash in the feedstock or blend of the brick.

14. The process of claim 1 further comprising using fly ash in the feedstock or blend of the brick.

15. The process of claim 14 wherein the fly ash content ranges from about 10% to about 20% fly ash.

16. The process of claim 1 further comprising using at least 50% sediment material in a feedstock or blend of the brick, and limiting a sodium (Na) content of the sediment material to less than about 0.15%.

17. The process of claim 16 further comprising using fly ash in the feedstock or blend of the brick.

18. The process of claim 17 wherein the fly ash content ranges from about 10% to about 20% fly ash.

19. The process of claim 18 further comprising firing the bricks on edge.

20. A brick comprising:
a material sourced from a brackish waterway wherein the material includes at least 50% sediment material in a feedstock or blend of the brick, and a sodium (Na) content of the sediment material is less than about 0.15%.

21. The brick of claim 20 wherein the brick includes fly ash as a constituent material.

22. The brick of claim 21 wherein the fly ash content ranges from about 10% to about 20% of the feedstock or blend of the brick.
